(19) United States
(12) Patent Application Publication
(10) Pub. No.: US 2022/0203775 A1
(43) Pub. Date: Jun. 30, 2022

(54) PNEUMATIC TIRE

(71) Applicant: Toyo Tire Corporation, Itami-shi (JP)

(72) Inventor: Hirokazu SAKATA, Itami-shi (JP)

(73) Assignee: Toyo Tire Corporation, Itami-shi (JP)

(21) Appl. No.: 17/548,902

(22) Filed: Dec. 13, 2021

(30) Foreign Application Priority Data
Dec. 24, 2020 (JP) 2020-215741

(51) Int. Cl. B60C 11/03

(52) U.S. Cl. CPC B60C 11/0304; B60C 2011/0367; B60C 2011/0365

(57) ABSTRACT

The ground contact end is an end of a tread surface in the tire width direction in a state where the tire at an internal pressure of 230 kPa is under a load of 70% of the maximum load according to the load index. The predetermined region T is a region in a portion outside the ground contact end in the tire width direction and is defined between the ground contact end and a location spaced apart from the ground contact end by a distance corresponding to 8% or more and 15% or less of a width from the ground contact end to the other ground contact end in the tire width direction. The predetermined direction forms an angle of 0 degrees or more and 35 degrees or less with respect to a circumferential direction of the tire.

This application is based on and claims the benefit of priority from Japanese Patent Application No. 2020-215741, filed on 24 Dec. 2020, the content of which is incorporated herein by reference.

### BACKGROUND

### Field

The present invention relates to a pneumatic tire.

### Background

Tires having grooves formed in their treads have been known. For example, Japanese Unexamined Patent Application, Publication No. 2006-069435 discloses a tire that has, on its tread, a groove formed around the entire periphery of the tire in the circumferential direction of the tire and a groove extending at a predetermined angle with respect to the circumferential direction of the tire.

### SUMMARY

In recent years, there has been a growing demand in the tire market for improved braking performance (μ). Improvement of the μ leads to improvement of a Cfmax (friction coefficient of maximum lateral force). However, when a vehicle turns at a large steering angle, an excessively high Cfmax may cause the tires to grip too firmly, allowing the vehicle to roll significantly. Especially, in the case of a vehicle with a high center of gravity, such as a minivan, the center of gravity of the vehicle may become positioned outside the position of the vehicle's outer wheel, thereby considerably disrupting the vehicle's balance.

The present invention has been achieved in view of the above problem, and an object of the present invention is to provide a pneumatic tire capable of lowering a Cfmax when a vehicle is turning at a large steering angle.

A pneumatic tire of the present invention includes a tread having a tread surface adapted to come into contact with a road surface. The tread has, in a predetermined region outside a ground contact end, a groove extending in a predetermined direction. The ground contact end is an end of the tread surface in the tire width direction in a state where the pneumatic tire at an internal pressure of 230 kPa is under a load of 70% of a maximum load according to a load index. The predetermined region is a region in a portion outside the ground contact end in the tire width direction and is defined between the ground contact end and a location spaced apart from the ground contact end by a distance corresponding to 8% or more and 15% or less of a width from the ground contact end to the other ground contact end in the tire width direction. The predetermined direction forms an angle of 0 degrees or more and 35 degrees or less with respect to a circumferential direction of the pneumatic tire.

The present invention provides a pneumatic tire capable of lowering a Cfmax when a vehicle turns at a large steering angle.

### BRIEF DESCRIPTION OF THE DRAWINGS

FIG. 1 is a cross-sectional view of a tire according to a first embodiment, taken along a tire width direction;

FIG. 2 is a diagram illustrating the tire of FIG. 1 as viewed along the arrow II, in a state where a vehicle is moving straight ahead;

FIG. 3 is a diagram illustrating the tire of FIG. 1 as viewed along the arrow II, in a state where the vehicle is turning to the left;

FIG. 4 is a diagram illustrating a tire according to a second embodiment as viewed in the same direction as that along the arrow II in FIG. 1, in a state where a vehicle is moving straight ahead; and

FIG. 5 is a diagram illustrating the tire according to the second embodiment as viewed in the same direction as that along the arrow II in FIG. 1, in a state where the vehicle is turning to the left.

### DETAILED DESCRIPTION OF THE EMBODIMENTS

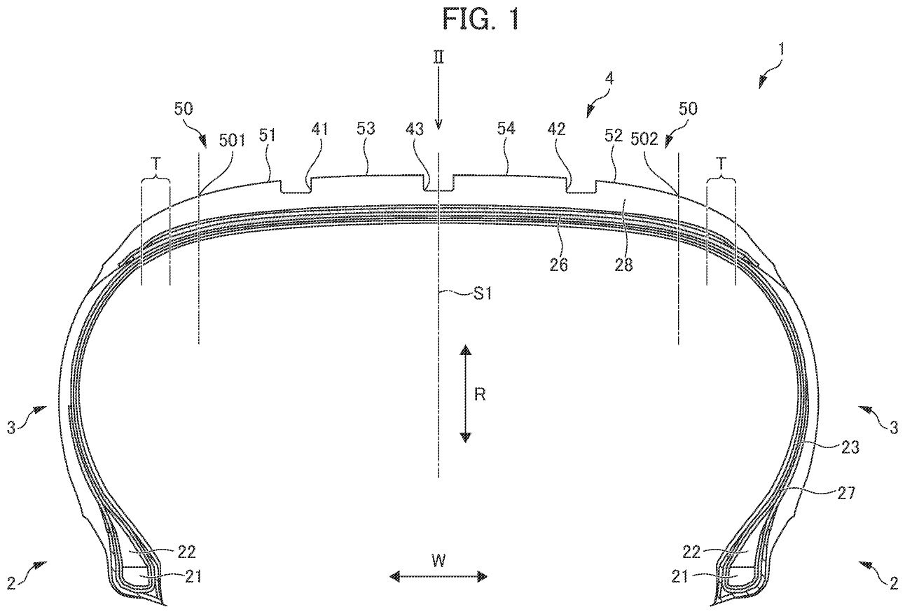

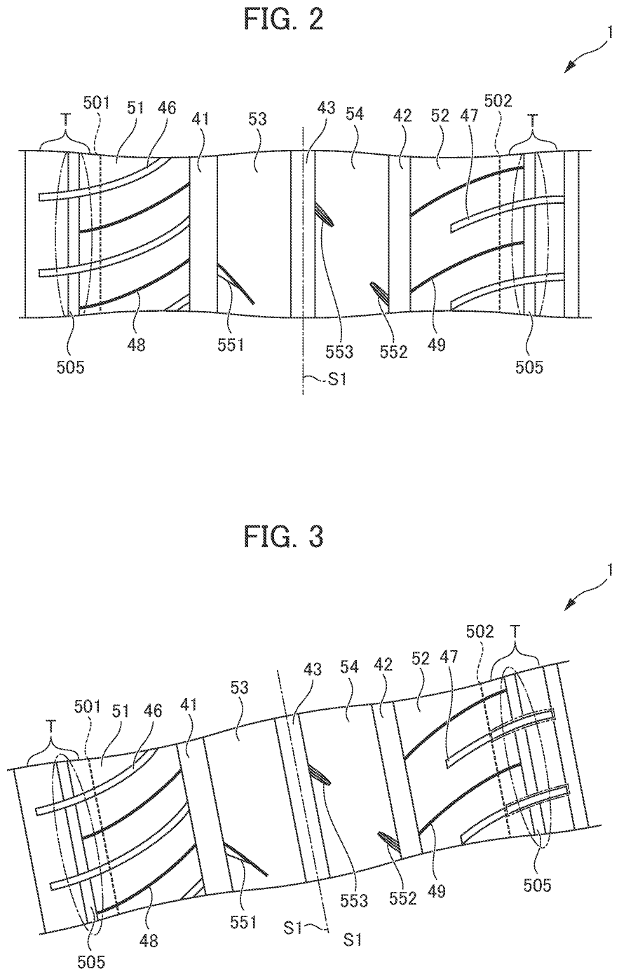

A first embodiment of the present disclosure will be described below with reference to the drawings. FIG. 1 is a cross-sectional view of a tire 1, taken along a tire width direction. FIG. 2 is a diagram illustrating the tire 1 of FIG. 1 as viewed along the arrow II, in a state where a vehicle is moving straight ahead. FIG. 3 is a diagram illustrating the tire 1 of FIG. 1 as viewed along the arrow II, in a state where the vehicle is turning to the left. In the drawings, the reference character “S1” denotes a tire equatorial plane. The tire equatorial plane S1 is a plane that is orthogonal to a tire rotation axis (tire meridian) and is located at the center in the tire width direction.

Here, the tire width direction is a direction parallel to the tire rotation axis, and corresponds to the lateral direction on the page of the cross-sectional view as FIG. 1. In FIG. 1, the tire width direction is denoted by “W”. “Inside/inward in the tire width direction” refers to a direction toward the tire equatorial plane S1. “Outside/outward in the tire width direction” refers to a direction away from the tire equatorial plane S1. For the sake of convenience, inside and outside in a width direction of a vehicle on which the tire is mountable are defined as the left side and right side in FIG. 1, respectively.

A tire radial direction is a direction perpendicular to the tire rotation axis, and corresponds to the vertical direction on the page of FIG. 1. In FIG. 1, the tire radial direction is denoted by “R”. “Outside/outward in the tire radial direction” refers to a direction away from the tire rotation axis, and corresponds to the upward direction on the page of FIG. 1. “Inside/inward in the tire radial direction” refers to a direction toward the tire rotation axis, and corresponds to the downward direction on the page of FIG. 1.

The cross-sectional view illustrated in FIG. 1 is a cross section (including the tire meridian) of the tire 1 that is mounted on a predetermined rim and filled at a predetermined internal pressure in an unloaded state. The cross-sectional view is taken along the tire width direction. The predetermined rim refers to a standard rim determined by JATMA in accordance with the tire size. The predetermined internal pressure is, for example, 180 kPa when the tire 1 is a tire for passenger cars.

The tire 1 according to the present embodiment includes a pair of beads 2 provided on both sides in the tire width direction, sidewalls 3 respectively extending outwardly in the tire radial direction from the beads 2, and an annular tread 4 extending in the circumferential direction of the tire 1 and having a tread surface that is adapted to come into contact with a road surface and that is continuous with outer portions of the sidewalls 3, the outer portions being located outside in the tire radial direction. Shoulders 50 are formed outside the tread 4 in the tire width direction.

Each bead 2 includes a bead core 21 that is an annular bundle formed by winding a rubber-coated metal bead wire by a plurality of turns, and a bead filler 22 that is made of rubber and has the bead core 21 embedded therein. The bead core 21 is a member allowing the tire 1 filled with air to be fixed to the rim (rim flange) of a wheel (not illustrated). The bead filler 22 is a member that increases rigidity of a bead peripheral portion and ensures high maneuverability and stability.

The tire 1 includes a carcass ply (23, 27) embedded therein. The carcass ply (23, 27) serves as a skeleton of the tire 1. The carcass ply (23, 27) is constituted by a two-layer carcass ply including a first carcass ply 23 and a second carcass ply 27 overlayered on each other. However, the carcass ply (23, 27) may be composed of a single layer or three or more layers.

As illustrated in in FIGS. 1 and 2, the tread 4 includes a belt 26 that is embedded at a position outside the carcass ply (23, 27) in the radial direction, and a tread rubber 28 that has the belt 26 embedded therein, is disposed outside the belt 26 in the tire radial direction, and has an outer surface serving as the tread surface. The tread rubber 28 has a plurality of main grooves 41, 42, 43, each of which continuously extends around the tire 1 in the tire circumferential direction. The main grooves 41, 42, 43 each extend continuously in the tire circumferential direction.

Among the plurality of main grooves 41, 42, 43, the main grooves 41, 42 that are the outermost two in the tire width direction constitute a pair of shoulder main grooves 41, 42. In more detail, the shoulder main groove 41 located inside with respect to the vehicle constitutes an inner shoulder main groove 41 as an inner main groove, while the shoulder main groove 42 located outside with respect to the vehicle constitutes an outer shoulder main groove 42 as an outer main groove. The main groove 43 located between the pair of shoulder main grooves 41, 42 constitutes a center main groove 43.

The tread 4 includes an inner shoulder land 51, an outer shoulder land 52, an inner center land 53, and an outer center land 54.

The inner shoulder land 51 is constituted by a land delimited by the shoulder main groove 41 and a ground contact end 501. The outer shoulder land 52 is constituted by a land delimited by the shoulder main groove 42 and a ground contact end 502. As illustrated in FIG. 2, the inner shoulder land 51 has grooves 46 and sipes 48 formed thereon, and the outer shoulder land 52 has grooves 47 and sipes 49 formed thereon.

The ground contact ends 501, 502 refer to the ends of the tread surface in the tire width direction in a state where the vehicle is moving straight ahead, while the internal pressure of the tire is 230 kPa and the tire is loaded at 70% of the maximum load according to the load index. For example, as will be described later, when the vehicle having the tire 1 mounted thereon turns while making the tire 1 slant to the left as illustrated in FIG. 3, a region outside the ground contact end 502 in the tire width direction (the region on the right of the ground contact end 502 in FIG. 3) i.e., the region denoted by “T” also comes into contact with the ground.

The inner center land 53 is constituted by a land delimited by the main grooves 41, 43 adjacent to each other. The outer center land 54 is constituted by a land delimited by the main grooves 42, 43 adjacent to each other. As illustrated in FIG. 2, the inner center land 53 has slits 551 formed thereon, and the outer center land 54 has slits 552, 553 formed thereon.

As illustrated in, for example, FIG. 2, the tread 4 has grooves 505 each extending in a predetermined direction in an area in an associated one of the predetermined regions T outside the ground contact ends 501, 502, the area being surrounded by a dot-dash curve in the drawings. Specifically, the predetermined region T is a region in a portion that is not in contact with the ground when the vehicle having the tire 1 is moving straight ahead as illustrated in FIG. 2, and that comes into contact with the ground when the vehicle having the tire 1 turns while making the tire 1 slant to the left at an angle of about 10° as illustrated in FIG. 3.

More specifically, the predetermined regions T are regions in portions outside the ground contact ends 501, 502 in the width direction of the tire 1 (i.e., in FIG. 2, a portion on the left of the ground contact end 501 and a portion on the right of the ground contact edge 502). Each predetermined region T is defined between the associated one of the ground contact ends 501, 502, and a location spaced apart from the associated ground contact end by a distance corresponding to 8% or more and 15% or less of a width from the ground contact end 501 to the ground contact end 502 in the width direction of the tire 1. This is because if the distance from the ground contact end 501, 502 corresponds to less than 8%, the Cfmax (friction coefficient of maximum lateral force) will become lower than necessary. This is also because if the distance from the ground contact end 501, 502 exceeds 15%, the effect of lowering the Cfmax cannot be exerted when the vehicle is turning.

The predetermined direction refers to a direction that forms an angle of 0 degrees or more and 35 degrees or less with respect to the circumferential direction of the tire 1. In other words, while the circumferential direction of the tire 1 includes one circumferential direction (the clockwise direction) and the other circumferential direction opposite to the one circumferential direction (the counterclockwise direction), it is suitable for the predetermined direction to form an angle of 0 degrees or more and 35 degrees or less with respect to either one of the circumferential directions. This is because if the angle with respect to the circumferential direction exceeds 35 degrees, a pressure from the road surface on the edge of the opening of the groove 505 is prevented from increasing, thereby making it difficult to lower the braking performance (μ). More preferably, the predetermined direction forms an angle of 0 degrees or more and 15 degrees or less with respect to either one of the circumferential directions. This is because an angle of 15 degrees or less makes it possible to sufficiently lower the braking performance (μ).

As illustrated in, for example, FIG. 2, each of the grooves 505 continuously extend around the entire periphery of the tire 1 in the circumferential direction of the tire 1. In this case, the aforementioned predetermined direction forms an angle of 0 degrees with respect to the circumferential direction of the tire 1. It is suitable for the groove 505 to have a depth of 0.5 mm or more. The depth is 1.5 mm in the present embodiment. It is suitable for the groove 505 to have a width of 0.5 mm or more. The width is 4.0 mm in the present embodiment. This is because if the width of the groove 505 is less than 0.5 mm, a contact area with the road surface cannot be reduced sufficiently when the vehicle turns.

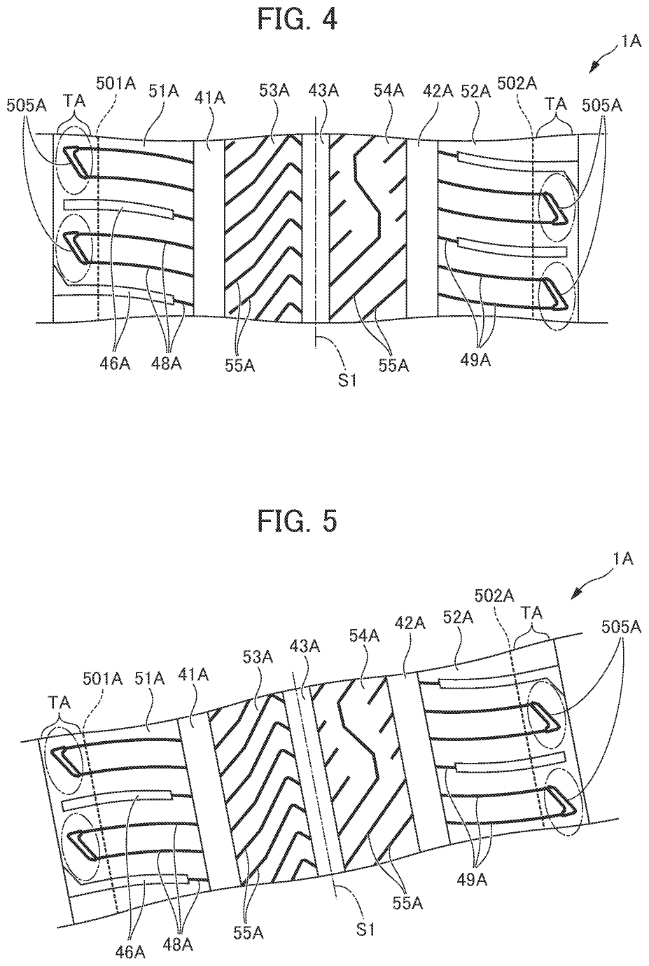

Next, a second embodiment of the present disclosure will be described with reference to the drawings. FIG. 4 is a diagram illustrating a tire 1A, as viewed in the same direction as that along the arrow II in FIG. 1. FIG. 5 is a diagram illustrating the tire 1A as viewed in the same direction as that along the arrow II in FIG. 1, in a state where the vehicle is turning.

The second embodiment has grooves 505A that differ in configuration from the grooves 505 of the first embodiment. This is a main difference between the first and second embodiments. In addition, other grooves 46A, sipes 48A, 49A, 55A, etc. of the second embodiment differ in configuration from the grooves 46, 47, the sipes 48, 49, etc., of the first embodiment. Except for the foregoing, the configuration of the second embodiment is the same as that of the first embodiment. The same components and elements are denoted by the same reference characters in the drawings, and a description of the same components and elements is omitted herein. Specifically, as illustrated in FIG. 4, the plurality of sipes 55A are formed on an inner center land 53A and an outer center land 54A. On an inner shoulder land 51A and an outer shoulder land 52A, sipes 48A, 49A extending in the width direction of the tire 1A are formed, respectively. Furthermore, the grooves 505A on the inner shoulder land 51A extend to span ends of the sipes 48A, the ends being located outside in the width direction of the tire 1A. The grooves 505A on the outer shoulder land 52A extend to span ends of the sipes 49A, the ends being located outside in the width direction of the tire 1A. Between the grooves 505A and 505A adjacent to each other in the circumferential direction of the tire 1A, the sipe 48A extends in the width direction of the tire 1A and the groove 46A extends further from the end of the sipe 48A. The grooves 505A extends in a direction that forms an angle of 35 degrees with respect to the circumferential direction of the tire 1A. The grooves 505A has a depth of 0.5 mm and a width of 2.0 mm.

Next, evaluation of the following examples will be described: the tire 1 according to the first embodiment as Example 1, the tire 1A according to the second embodiment as Example 2, and a conventional tire provided as Comparative Example 1. The conventional tire of Comparative Example 1 had the same configuration as that of the tire 1 of Example 1 except that the predetermined regions T outside the ground contact ends 501, 502 were not provided with the above-described grooves 505 extending in the predetermined direction. Further, a conventional tire provided as Comparative Example 2 was evaluated. The conventional tire of Comparative Example 2 had the same configuration as that of the tire of Example 2 except that the predetermined regions T outside the ground contact ends 501A, 502A were not provided with the above-described grooves 505A extending in the predetermined direction.

### <Evaluation of Rolling Resistance (RRC)>

Each test tire with a size of 205/60R16 92H was mounted on a standard rim at an air pressure of 230 kPa, and an evaluation test was conducted to evaluate rolling resistance. In the rolling resistance test, a uniaxial drum-type tester for measuring rolling resistance was used to measure rolling resistance at a load of 400 kg and a speed of 60 km/h. The rolling resistance of the test tire of Comparative Example 1 was defined as an index of 100, and an index-based evaluation was conducted on the tire of Example 1.

### <Evaluation of Braking Distance>

A braking distance evaluation test was conducted on each test tire with a size of 205/60R16 92H, mounted on a standard rim at an air pressure of 230 kPa. In this evaluation test, the tires were mounted on a test vehicle (a front-wheel drive minivan with a displacement of 2000 cc), and the test vehicle traveled on a dry road surface. A braking force was made to act by an antilock brake system (ABS) when the test vehicle was moving at a speed of 100 km/h, so that a braking distance at which the test vehicle stopped at a speed of 0 km/h was measured for the evaluation. The braking distance of the test tire of Comparative Example 1 was defined as an index 100, and an index-based evaluation was conducted on the tire of Example 1.

### <Evaluation of Cornering Power (CP)>

Using a drum-type tester with a diameter of 2500 mm, a cornering force generated on the tire 1 with a size of 205/60R16 92H at an internal pressure of 230 kPa was measured while the tire 1 was subjected to a load at 70% of the maximum load according to the load index. A cornering force at a slip angle of 1 degree was determined in the evaluation test. The result of Comparative Example 1 was defined as an index of 100, and an index-based evaluation was conducted.

### <Evaluation of Maximum Value of Cornering Force (Cfmax)>

A test for evaluating a maximum value of cornering force was conducted in the following manner. Each test tire with a size of 205/60R16 92H was mounted on a standard rim at an air pressure of 230 kPa. Under a load at 70% of the maximum load according to the load index, the test tire was tested at a traveling speed of 80 km/h using a flat belt-type cornering tester. While a steering angle was gradually increased, the maximum value of cornering force (Cfmax) was measured for the evaluation. The result of Comparative Example 1 was defined as an index of 100, and an index-based evaluation was conducted.

TABLE 1

| | | Braking | | |
|---|---|---|---|---|
| | RRC | Distance | CP | Cfmax |
| Comparative | 100 | 100 | 100 | 100 |
| Example 1 | | | | |
| Example 1 | 100 | 100 | 100 | 97 |

TABLE 2

| | | Braking | | |
|---|---|---|---|---|
| | RRC | Distance | CP | Cfmax |
| Comparative | 100 | 100 | 100 | 100 |
| Example 2 | | | | |
| Example 2 | 100 | 100 | 100 | 98 |

Table 1 shows that Example 1 has a lower Cfmax than Comparative Example 1 having the conventional configuration, while demonstrating performance comparable to that of Comparative Example 1 in relation to all of the RRC, the braking distance, and the CP.

Table 2 shows that although Example 2 is not as good as Example 1, Example 2 has a lower Cfmax than Comparative Example 2 having the conventional configuration. It can be appreciated that like Example 1, Example 2 demonstrates performance comparable to that of Comparative Example 2 in relation to of all of the RRC, the braking distance, and the CP.

As described above, Example 1 has the grooves 505 that extend in the direction forming an angle of 0 degrees with respect to the circumferential direction of the tire 1, and the depth and width of the grooves 505 are 1.5 mm and 4.0 mm, respectively. As described above, Example 2 has the grooves 505A that extend in the direction forming an angle of 35 degrees with respect to the circumferential direction of the tire 1A, and the depth and width of the grooves 505A are 0.5 mm and 2.0 mm, respectively.

Thus, it can be appreciated that favorable results are obtained in both Example 1 and Example 2, in which the depth of the grooves is 0.5 mm or more and the width of the grooves is in the range from 1.0 mm to 4.0 mm.

The tire 1 according to the present embodiment exerts the following effects. On the tread of the tire 1 (1A) of the present embodiment, the grooves 505 (505A) extending in the predetermined direction are arranged in the predetermined regions T (TA) outside the ground contact ends 501, 502 (501A, 502A). The ground contact ends 501, 502 (501A, 502A) are ends of the tread surface in the width direction of the tire 1 (1A) in a state where the tire 1 (1A) at an internal pressure of 230 kPa is under a load of 70% of the maximum load according to the load index. Each predetermined region T (TA) is a region in a portion outside an associated one of the ground contact ends 501, 502 (501A, 502A) in the width direction of tire 1 (1A), and is defined between the associated one of the ground contact ends 501, 502 (501A, 502A) and a location spaced apart from the associated one of the ground contact ends 501, 502 (501A, 502A) by a distance corresponding to 8% or more and 15% or less of the width from the ground contact end 501 (501A) to the ground contact end 502 (502A) in the width direction of the tire 1 (1A), i.e., the ground contact width of the tire 1 (1A). The predetermined direction forms an angle of 0 degrees or more and 35 degrees or less with respect to the circumferential direction of the tire 1 (1A).

This feature makes it possible to reduce the contact area with the road surface when the vehicle is turning, and to increase an average pressure at which the tread surface contacts with the ground. As a result, the friction coefficient can be reduced. The Cfmax is calculated according to the expression: “lateral friction coefficient x vertical load”. Since the friction coefficient can be reduced as described above, the Cfmax can be lowered when the vehicle is turning at a large steering angle. Furthermore, the grooves 505 (505A) are arranged in the portions that are apart from the ground in a steady state. This feature makes it possible to avoid impairing the maneuverability and braking performance in the steady state.

According to the tire 1 (1A) of the present embodiment, the predetermined direction forms an angle of 0 degrees or more and 15 degrees or less with respect to the circumferential direction of the tire 1 (1A). This feature allows the braking performance (μ) to be sufficiently lowered. As a result, the Cfmax can be lowered sufficiently.

In the tire 1 (1A) of the present embodiment, the grooves 505 (505A) are formed around the entire periphery of the tire 1 (1A) in the circumferential direction of the tire 1 (1A). Due to this feature, the grooves 505 (505A) are present at any position in the circumferential direction of the tire 1 (1A), thereby making it possible to lower the Cfmax.

According to the tire 1 (1A) of the present embodiment, the grooves 505 (505A) have a depth of 0.5 mm or more. This feature makes it possible to sufficiently increase a non-ground-contact area when the vehicle is turning. As a result, the Cfmax can be lowered sufficiently.

According to the tire 1 (1A) of the present embodiment, the grooves 505 (505A) have a width of 1.0 mm or more and 4.0 mm or less. This feature makes it possible to sufficiently increase the non-ground-contact area when the vehicle is turning. As a result, the Cfmax can be lowered sufficiently.

It should be noted that the above embodiments are not intended to limit the present invention. The scope of the present invention encompasses modifications and improvements that are made in the range where the object of the present invention can be achieved. For example, in the first embodiment, the grooves 505 continuously extend around the entire periphery of the tire 1 in the circumferential direction of the tire 1. However, the present invention is not limited to this configuration. It is suitable for the grooves to be formed around the entire periphery of the tire in the circumferential direction of the tire. For example, the grooves may be discontinuously formed around the entire periphery of the tire in the circumferential direction of the tire. Alternatively, the grooves may be formed in a zigzag shape around the entire periphery of the tire in the circumferential direction of the tire.

What is claimed is:

1. A pneumatic tire comprising: a tread having a tread surface adapted to come into contact with a road surface,
wherein the tread has, in a predetermined region outside a ground contact end, a groove extending in a predetermined direction,
wherein the predetermined region corresponds to 8% or more and 15% or less of a ground contact width of the pneumatic tire, and
wherein the predetermined direction forms an angle of 0 degrees or more and 35 degrees or less with respect to a circumferential direction of the pneumatic tire.

2. The pneumatic tire according to claim 1,
wherein the predetermined direction forms an angle of 0 degrees or more and 15 degrees or less with respect to the circumferential direction of the pneumatic tire.

3. The pneumatic tire according to claim 1,
wherein the groove is formed around an entire periphery of the pneumatic tire in the circumferential direction of the pneumatic tire.

4. The pneumatic tire according to claim 2,
wherein the groove is formed around an entire periphery of the pneumatic tire in the circumferential direction of the pneumatic tire.

5. The pneumatic tire according to claim 3,
wherein the groove is continuous in the circumferential direction of the pneumatic tire.

6. The pneumatic tire according to claim 4,
wherein the groove is continuous in the circumferential direction of the pneumatic tire.

7. The pneumatic tire according to claim 3,
wherein the groove has a depth of 0.5 mm or more.

8. The pneumatic tire according to claim 4,
wherein the groove has a depth of 0.5 mm or more.

9. The pneumatic tire according to claim 5,
wherein the groove has a depth of 0.5 mm or more.

10. The pneumatic tire according to claim 6,
wherein the groove has a depth of 0.5 mm or more.

11. The pneumatic tire according to claim 3,
wherein the groove has a width between 1.0 mm and 4.0 mm.

12. The pneumatic tire according to claim 4,
wherein the groove has a width between 1.0 mm and 4.0 mm.

13. The pneumatic tire according to claim 5,
wherein the groove has a width between 1.0 mm and 4.0 mm.

14. The pneumatic tire according to claim 6,
wherein the groove has a width between 1.0 mm and 4.0 mm.

15. The pneumatic tire according to claim 7,
wherein the groove has a width between 1.0 mm and 4.0 mm.

16. The pneumatic tire according to claim 8,
wherein the groove has a width between 1.0 mm and 4.0 mm.

17. The pneumatic tire according to claim 9,
wherein the groove has a width between 1.0 mm and 4.0 mm.

18. The pneumatic tire according to claim 10,
wherein the groove has a width between 1.0 mm and 4.0 mm.
